(19) United States
(12) Patent Application Publication
(10) Pub. No.: US 2010/0218600 A1
(43) Pub. Date: Sep. 2, 2010

(54) DEVICE AND METHOD FOR DETERMINING THE QUANTITY OF SUBSTANCE IN SMALL CAVITIES

(76) Inventors: Jörg Auge, Wolmirstedt (DE); Axel Hoppe, Gerwisch (DE); Hendrik Arndt, Tangermunde (DE)

Correspondence Address: David W. Highet, VP & Chief IP Counsel;Becton, Dickinson and Company, 1 Becton Drive, MC 110, Franklin Lakes, NJ, 07417-1880, US

(21) Appl. No.: 12/524,739

(22) PCT Filed: Jan. 30, 2008
(86) PCT No.: PCT/EP2008/051131

§ 371 Date: Feb. 3, 2010

(30) Foreign Application Priority Data
Jan. 31, 2007 (DE) 10 2007 005 618.6

(51) Int. Cl. G01F 23/292

(52) U.S. Cl. 73/295

(57) ABSTRACT

The invention describes a method and a device for simultaneously determining the mass, volumes or types of substance samples in a plurality of small cavities (2), particularly of wells in microtiter plates. According to the method, energy is supplied by an energy source (5) to the wells, which are partially or completely filled with samples. Depending on the mass thereof, the samples thus heat up more or less strongly. The determination of the substance volumes in the individual cavities is therefore based on temperature measurement. The simultaneous capturing of the sample temperature in the individual cavities can advantageously be performed by an infrared camera functioning as a detector (6). By implementing suitable calibration and measurement routines in an evaluation unit (7), the entire system, which substantially comprises an energy source and a detector, can be configured such that the substance volumes in the individual cavities are displayed directly.

### PRIOR ART

During recent decades, microtiter plates have come to be used in numerous areas of biology, pharmaceutics and medical technology, in order to facilitate the simultaneous handling of multiple samples. They are used for photometric or fluorometric screening tests, in cell culture technology, or for the storage of samples. A wide variety of microtiter plates are now available, generally made of transparent plastics such as polystyrene or polypropylene. Typically, they have 96, 384 or, in recent versions, as many as 1,536 so-called “wells”; other array configurations are, however, also available. In 96-well microtiter plates, each well normally has a maximum filling volume of between 300 and 400 μl; for a 384-well array this is approximately 100 μl, and for a 1,536-well array approximately 10 μl. The preferred sample volume is usually approximately 20% to 80% of the maximum possible filling volume. In the use of microtiter plates, problems can arise through the evaporation of small sample quantities and the formation of menisci at the well walls. When microtiter plates are simultaneously automatically filled using suitable dispensing heads, it can occur that incorrect quantities are dispensed.

It would therefore be desirable to have a measurement method and device for determining quickly and with the greatest possible accuracy the fill level, i.e. the mass and/or the volume of the substance sample in each individual well of an array.

The invention relates to a method and a device for determining simultaneously the mass and/or the volume of the substance sample in each individual well of microtiter plates.

US Patent US005307144A discloses a photometric method for gaining information about biochemical and biological reactions such as enzyme reactions. In this, light is generated by a monochrome light source and subsequently transmitted through all wells in the microtiter plate. An array of detectors is disposed above the microtiter plate to detect the intensity of the light transmitted. Depending on the wavelength of the light that is generated, information about the reactions or the concentrations of the substance present can thereby be obtained. Determination of the fill levels of the individual wells is not the aim of the method and the device that is described.

European patent EP0648536A1 proposes and describes a multiwell arrangement for use in instrumental analysis. The aim of the proposed arrangement is to adjust the surface tension at the liquid surface through the use of two different materials, so that the formation of menisci is minimized and an almost flat surface of the liquid is formed, facilitating analyses and observations greatly.

In order to determine fill levels of large sample quantities, there exist a multiplicity of different measurement procedures and commercial measuring devices which may be used for this purpose. These include in particular:
capacitance fill level measurement,
ultrasound fill level measurement,
fill level measurement with radar or microwaves,
hydrostatic fill level measurement,
gravimetric fill level measurement,
   and other more or less significant measurement procedures.

The aim as described of measuring the fill level in microtiter plates exhibits several particular technical measurement problems:
1. The diameter of the individual wells in the microtiter plates is only a few millimeters, which requires highly spatially resolved and focused measurement.
2. The fill levels and/or sample quantities which are to be determined are exceptionally small, and require in extreme cases resolutions in the nanometer or nanogram range.
3. The smaller the sample quantities to be determined, the more wells—and hence measurement points—the arrays have.
4. The measurement should be rapid, which virtually rules out sequential scanning of the individual fill levels (above all in the case of large arrays).
5. The microtiter plates are mostly composed of plastic which is almost optically transparent, with the liquids in the wells often also almost optically transparent.
6. The wells are mostly in the form of cylinders, with a depth approximately equaling their diameter. But the level of liquid which is to be determined is significantly less than half of the depth of the cylinder, which impedes access to the boundary surface for measurement purposes.
7. The liquids form menisci at the walls of the wells, above all in very small wells, which also impedes ascertainment of the boundary surface for measurement purposes.

A method for determination of the fill levels and/or sample quantities in the individual cavities or wells of a microtiter plate, which can be used for online quality control of automatically filled microtiter plates, is not known.

### NATURE OF THE INVENTION

The method according to the invention and the devices based on it are intended to solve this problem.

At the present time, measurement which is spatially resolved and rapid, and thus simultaneous, at a large number of points, is possible only based on the use of cameras. Determining the fill levels in the individual wells with a normal camera proves to be, however, extremely problematic due to the reasons described above (in particular 2, 5, 6 and 7). Using such means it is certainly possible to state in yes/no terms whether the wells are filled. Quantification of the individual fill levels to an accuracy of a few percent is, however, not thereby realizable with any tenable design.

In order nevertheless to solve the problem with camera based systems, a way must be found to convert the geometric quantity of the fill level height into another physical quantity which is directly correlated with the fill level height. According to the invention, this takes place through the introduction of a defined quantity of energy. If one can succeed in delivering an identical quantity of energy to each cell directly in the form of heat, or delivering the energy in such a manner that the energy is converted to heat in the fluid, the following applies:

∂Q=m·c·∂T=ρ·V·c·∂T=ρ·A_{Well}·h_{P}·c·∂T (1),

where Q is the quantity of heat, m is the mass of the sample, c is the specific heat capacity of the sample, p is the density of the sample and V is the volume of the sample. If an identical heat quantity Q is introduced into each well, different sample volumes V or fill level heights h_{P} in the wells with the surface area A_{Well} lead to differing rises in the temperatures of the samples. If the sample materials are identical, it thus holds that the smaller the volume of the sample, the greater the temperature rise in that sample.

Because the microtiter plate is generally composed of a material which is a very bad conductor of heat, and the wells are mostly separated from each other by air gaps which also conduct heat badly, thermal equalization processes take place only very slowly between the wells, and thus have hardly any negative effect on the measurement.

In this way, the technical problem of measurement of the fill level height can be converted into a measurement of temperature. To do this, specified energy is introduced into the microtiter plate. This can take place, for example, by means of heating plates or radiant heaters, but can equally be in the form of microwave radiation, which is absorbed in the samples depending on their dipole moment.

As a detector array for the spatially resolved temperature measurement, infrared thermal imaging cameras are suitable. In order to determine the volumes of the samples from the temperature values which are detected, the specific heat capacity of the samples must be known. Then, with the aid of an evaluation unit, for instance a PC connected with the infrared camera, using suitable calibration algorithms, the fill level heights and/or the sample volumes can be calculated from the measured temperature values. To show the results, a numerical display is less advisable than a false color representation, such as is also usual in thermal images. The colors are now allocated, however, directly to fill levels or sample volumes. For use in quality checking it would be advisable, for example, to allocate the color green to the desired value of the sample volume. Underfilling can then, for example, be indicated by shades of yellow or blue, and overfilling by shades of red. In this, the changes of color which represent the measured fill levels can be continuous or in discrete steps reflecting assignment to ranges.

It is sufficiently known that the fill level of containers can be measured using infra-red cameras. In this, use is made of the differing heat capacities of the filling substance and the air above it. In this way the fill level can be identified optically as a boundary layer through the wall of the container based on the temperature differences. Here, however, the fill level is determined as a geometrical measurement, and not, as in the method according to the invention, derived from a temperature.

The impulse thermography method is also known. In this, the thermal equilibrium of a sample is disturbed by the introduction of energy. If the sample to be tested is not homogeneous, but rather has defective areas, inclusions or similar, these defect regions reveal themselves due to the differing heat capacity and the differing thermal conductivity.

In the method according to the invention, however, the measurement problem of a spatially resolved fill level measurement. i.e. of a geometrical quantity, is converted to the measurement problem of a spatially resolved temperature measurement.

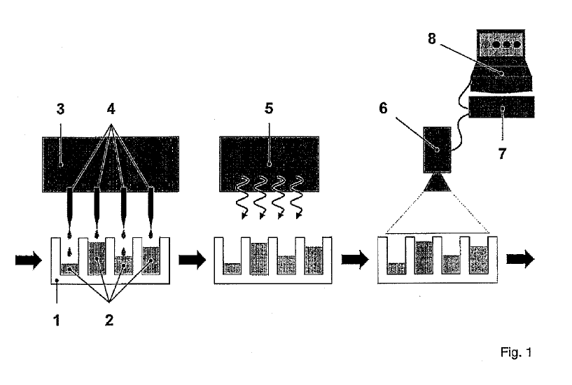

An example embodiment of a device corresponding to the method according to the invention is shown in FIG. 1.

In a base carrier (1), for example a microtiter plate, are disposed a plurality of cavities (2), which can have a variety of geometrical forms, but typically have a round cross-section and a height which is approximately equal to the cavities' diameter.

Samples are introduced into the individual cavities (2), for example by a dispensing device (3), whereby the dispensing device (3) normally has a plurality of dispensing orifices (4) arranged in one row or in an array. After the filling process, individual cavities may contain differing quantities of the sample substance, either intentionally or unintentionally. which means that their fill levels also differ.

Determination of the fill levels of the individual cavities (2) can be carried out according to the invention by means of the subsequent introduction of energy into the cavities, with ideally the same quantity of energy introduced into each individual cavity. In this, the energy can for example be supplied as heat by radiation. Heat can also be supplied, for example, by heat conduction through the bottom of the base carrier (1) by means of a heating plate. In addition to the supply of energy in the form of heat, it is also possible to use other sources of energetic radiation, for example a microwave source. If the energy supplied to each cavity is identical, as in the ideal case, the less sample substance is present in a cavity, the more strongly it is heated. According to equation (1) there is a direct correlation between quantity of energy and quantity of sample material. Thermal equalization processes between the individual cavities, for example in the case of microtiter plates, take place only slowly, since the material of the base carrier, and/or the air between the cavities, have very low heat conductivity. Thus by the capture of the temperature of the sample, the quantity of the sample can be inferred when the characteristics of the sample are known. To capture temperatures in a simultaneous and spatially resolved manner, it is advisable to use an infrared thermal imaging camera as a detector (6). The thermal image contains the required information concerning the fill levels of the individual cavities. Using an evaluation unit (7), which is connected with the detector (6), the fill level information which is sought can be determined using the measured temperature values and the previously stored characteristics of the material. The fill level can be displayed with the aid of a visualization device (8).

The method according to the invention, and the device described above which is based upon it, is very suitable for fitting to an existing apparatus with an automatic filling device, since in the ideal case no change to the existing filling procedure is required. There is no effect on the operation of any of the equipment. The energy source can be disposed behind the filling device above the supply device which is often present. The same applies to the detector. The only requirement is that the medium between the detector and the sample must be optically transparent. The introduction of energy must take place in such a manner that, on the one hand, the samples are not damaged by the heat, and on the other, that temperature differences are attained which can be quantified with sufficient accuracy using commercially available infrared thermal imaging cameras.

In a modified form, the method can also be used for the identification of material rather than the determination of fill levels. According to equation (1) the quantity of heat introduced is directly proportional to the mass of the sample and to the specific heat capacity of the material. If it can be ensured that all wells of the microtiter plate have been filled with the same volume, the captured and subsequently measured rise in temperature in each sample will now vary according to density and specific heat capacity. Thus it is possible to identify materials which differ sufficiently in their densities and specific heat capacities.

### ECONOMIC RELEVANCE OF THE INVENTION

The method according to the invention enables the determination of the fill levels of small cavities or sample containers by means of the conversion described of the determination of a geometric quantity by means of the measurement of the temperature.

Possible competing methods are progressively eliminated as the sample quantities decrease and the number of fill levels to be determined increases. Hence the greatest economic relevance attaches to the determination of fill levels in microtiter plates with in some cases more than 1,000 sample quantities which must be determined simultaneously.

The method according to the invention and devices based upon it are thus particularly suitable for the area of quality control of microtiter plates which are filled automatically and at rapid rates. When the filling is automatic, various sources of error can lead to the incorrect filling of individual wells due to errors which can be random and non-recurring, but can also be systematic. Possible such errors are:
the incomplete filling of dispenser heads, with the result that too little fluid is subsequently delivered to the corresponding wells.
residue of liquid remaining on the dispenser needles, which can lead first to underfilling and subsequently to one or more overfillings.
mechanical damage to the dispenser head, with the result that the alignment of each dispenser needle with the well below it is no longer ensured, or else incorrect quantities are delivered.

With the method according to the invention, it is possible to carry out a 100% check of the filled cavities or wells in microtiter plates with a high degree of accuracy. Because the test device can operate completely free of contact, the cost of installing it and integrating it into existing equipment is reduced to a minimum. No change is necessary to the design of the automatic filling devices and their dispenser heads, and their operating processes can remain largely or wholly unaltered. This reduces considerably in relative terms the comparably high cost of an infrared thermal imaging camera. It seems possible that the cost of a test device based on the procedure according to the invention can be rapidly amortized by the ensuring of product quality at a level higher than that previously known in circumstances of high throughput and production rates.

1-9. (canceled)

10. A device for monitoring or determining the mass, volume or mass and volume of a plurality of liquid samples, comprising:
a. a plurality of cavities arranged an array, each of the cavities configured to accept the liquid sample;
b. an energy source configured to direct energy to the cavities such that the liquid samples are heated;
c. a detector configured to detect the temperatures of the liquid samples in each of the plurality of cavities upon being heated by the energy source;
wherein the mass, volume or mass and volume of the liquid samples are monitored or determined based on the detected temperatures.

11. The device according to claim 10 wherein the detector is an infrared thermal imaging camera.

12. The device according to claim 10, wherein the detector detects the temperatures of all the liquid samples simultaneously.

13. The device according to claim 11 wherein the infrared camera is connected with an evaluation unit which, using sample and calibration data previously stored in the evaluation unit, calculates from the thermal image the volume, mass or volume and mass of the liquid samples in the cavities and subsequently displays, stores, or both displays and stores the volume, mass or volume and mass.

14. The device according to claim 13, wherein the calculation uses the following relationship:
∂Q=m·c·∂T=ρ·V·c·∂T=ρ·A_{Well}·h_{P}·c·∂T (1),
where Q is the quantity of heat, m is the mass of the sample, c is the specific heat capacity of the sample, p is the density of the sample and V is the volume of the sample, h_{P} is the fill level height in the well, A_{Well} is i the surface area of the well, and T is the temperature.

15. The device according to claim 13 wherein the evaluation unit is a computer.

16. The device according to claim 10 wherein the energy source heats the liquid samples by a technique selected from the group consisting of radiant heat, conduction, convection and microwave.

17. The device according to claim 10, further comprising the liquid samples present in at least a portion of the cavities.

18. The device according to claim 17 wherein the liquid samples are selected from the group consisting of suspensions, emulsions and solids dissolved in solvent.

19. The device according to claim 10 wherein the cavities arranged in an array are wells in a microtiter plate.

20. A system comprising the device according to claim 10 and a dispensing unit.

21. A method for determining monitoring or determining the mass, volume or mass and volume of a plurality of liquid samples, comprising the steps of:
a. dispensing liquid samples into a plurality of cavities arranged an array;
b. directing energy to the cavities such that the liquid samples are heated;
c. detecting the temperatures of the heated liquid samples in each of the plurality of cavities; and
d. monitoring or determine the mass, volume or mass and volume of the liquid samples based on the detected temperatures.

22. The method according to claim 20 wherein the detection is performed with an infrared thermal imaging camera which measures in a non-contact manner.

23. The method according to claim 21, wherein the energy is directed to all the cavities simultaneously, and wherein the temperatures of all the heated liquid samples are detected simultaneously.

24. The method according to claim 22 wherein the infrared camera is connected with an evaluation unit, and further comprising the step of, using sample and calibration data previously stored in the evaluation unit, calculating from the thermal image the volume, mass or volume and mass of the liquid samples in the cavities.

25. The method according to claim 24, wherein the calculation uses the following relationship:
∂Q=m·c·∂T=ρ·V·c·∂T=ρ·A_{Well}·h_{P}·c·∂T (1),
where Q is the quantity of heat, m is the mass of the sample, c is the specific heat capacity of the sample, p is the density of the sample and V is the volume of the sample, h_{P} is the fill level height in the well, A_{Well} is the surface area of the well, and T is the temperature.

26. The method according to claim 24, further comprising the step of displaying, storing or displaying and storing the volume, mass or volume and mass of the liquid samples.

27. The method according to claim 21 wherein the liquid samples are heated by radiant heat.

28. The method according to claim 21 wherein the liquid samples are heated by conduction.

29. The method according to claim 21 wherein the liquid samples are heated by convection.

30. The method according to claim 21 wherein the liquid samples are heated by microwave energy.

31. The method according to claim 21, wherein the liquid samples are selected from the group consisting of suspensions, emulsions, and solids dissolved in solvent.

32. The method according to claim 21, further comprising the step of dispensing the liquid samples into the cavities.
